(19) United States
(12) Patent Application Publication
(10) Pub. No.: US 2018/0223510 A1
(43) Pub. Date: Aug. 9, 2018

(54) CONNECTING DEVICE FOR COUPLING A TUBULAR MEMBER TO A THREADED TUBULAR PORT, IN PARTICULAR FOR WASHING MACHINES

(71) Applicant: BITRON POLAND SP. ZO.O, Sosnowiec (PL)

(72) Inventors: Jacek SADLON, KATOWICE (PL); Marek ZIELINSKI, KATOWICE (PL)

(73) Assignee: BITRON POLAND SP. ZO.O, SOSNOWIEC (PL)

(21) Appl. No.: 15/877,537

(22) Filed: Jan. 23, 2018

(30) Foreign Application Priority Data
Feb. 9, 2017 (PL) P.420480

(51) Int. Cl. E03C 1/184; F16L 41/00

(52) U.S. Cl. CPC E03C 1/184; F16L 41/10; F16L 41/007

(57) ABSTRACT

A connecting device for coupling a tubular member having on one end an outer shoulder or flange, in particular an inlet piping of a water supply electric control valve for a washing machine, to a threaded tubular port, in particular an outlet port of a water supply line or tap. The device includes a nut and a coupling ring interposed between the tubular member and the second end portion of the nut for connecting them to one another. The coupling ring is resiliently deformable in a radial direction mounted around the tubular member, in proximity of the end shoulder or flange thereof, such as to be prevented by the end shoulder or flange from being moved away from the tubular member, but to be allowed to freely rotate around the tubular member.

### BACKGROUND OF THE INVENTION

### Field of the Invention

The present invention relates to a connecting device for coupling a tubular member having on one end an outer shoulder or flange, in particular an inlet piping of a water supply electric control valve (such as a so-called “water-stop” control valve) for a washing machine (such as a clothes washing machine or a dishwasher), to a threaded tubular port, in particular an outlet port of a water supply line or a tap.

### SUMMARY OF THE INVENTION

An object of the present invention is to provide an improved connecting device, which allows to easily and quickly achieve a highly reliable connection between a tubular member and a threaded tubular port.

This and other objects are achieved according to the present invention by a connecting device comprising

a nut with a first threaded end portion adapted to be screw-coupled with said port and a second end portion adapted to receive said end of the tubular member, and

a coupling ring adapted to be interposed between the tubular member and said second end portion of the nut for connecting them to one another;

the coupling ring being resiliently deformable in the radial direction and being adapted to be mounted around the tubular member, in proximity of the end shoulder or flange thereof, such as to be prevented by said end shoulder or flange from being taken away from the tubular member, but to be allowed to freely rotate around said tubular member;

the second end portion of the nut and the coupling ring being threaded such as to allow the nut to be screw-fastened to the coupling member after the latter has been mounted on the tubular member, before the nut is screw-fastened to said tubular port;

the nut and the coupling ring being provided with respective first and second engagement means adapted to prevent them from being unscrewed one from the other.

### BRIEF DESCRIPTION OF THE DRAWINGS

Further features and advantages of the present invention will become apparent from the following description provided merely by way of a non-limiting example, with reference to the attached drawings, wherein

FIG. 1 is a perspective view of a water-stop control valve for a dishwasher, provided with a connecting device according to the present invention,

FIG. 2 is a perspective view showing a nut and a coupling member of a device according to the present invention in their mutually coupled condition;

FIG. 3 is a perspective view showing the nut and the coupling ring in an uncoupled condition;

FIG. 4 is a perspective, exploded, partial view showing a connecting device for coupling to a tubular inlet member of the water-stop control device of FIG. 1;

FIG. 5 is a partial perspective view showing the coupling ring of the connecting device of the present invention while being mounted onto the tubular inlet member of a water-stop control valve;

FIG. 6 is a partial perspective view showing the coupling ring mounted on the tubular inlet member of the water-stop control valve;

FIG. 7 is a partial perspective view showing the whole connecting device of the present invention in its mounted condition on the tubular inlet member of a water-stop control valve;

FIG. 8 is an enlarged, partial, perspective view, showing the connecting device of FIG. 7 in an essentially vertical cross-section; and

FIG. 9 is a partial perspective view showing a water-stop control valve coupled with a water supply tap through a connecting device according to the present invention.

### DETAILED DESCRIPTION OF THE INVENTION

In the following description a connecting device 1 according to the present invention will be described in details, with reference to an exemplary application thereto to a water-stop arrangement indicated as a whole with WSA.

In a per se known manner, the water-stop arrangement WSA comprises a water-stop electric control valve WSV in a housing H, typically made of a plastic material, having an inlet tubular member for receiving in the operation a flow of water from a water supply line and an outlet 3 for forwarding such a flow of water to a washing machine.

The outlet 3 is connected to an outer flexible tube 4, inside which another flexible tube 5 is provided. The latter is actually coupled with the water outlet of the water-stop valve WSV, whereas the annular chamber defined between the tubes 4 and is normally dry. Inside said annular chamber there are provided electric cables 6 to be connected with a control unit of a washing machine, for controlling the operation of the water-stop valve WSV.

The inner tube 5, which normally conveys water to the washing machine, ends with a hydraulic connector 7 (or other device, such as for instance a valve or a flow-meter) to be coupled with an internal pipe of the washing machine for conveying the flow of water to the washing tube or chamber of said machine.

The electric cables 6 are provided with an end connector 8, for connection with a control unit of the washing machine.

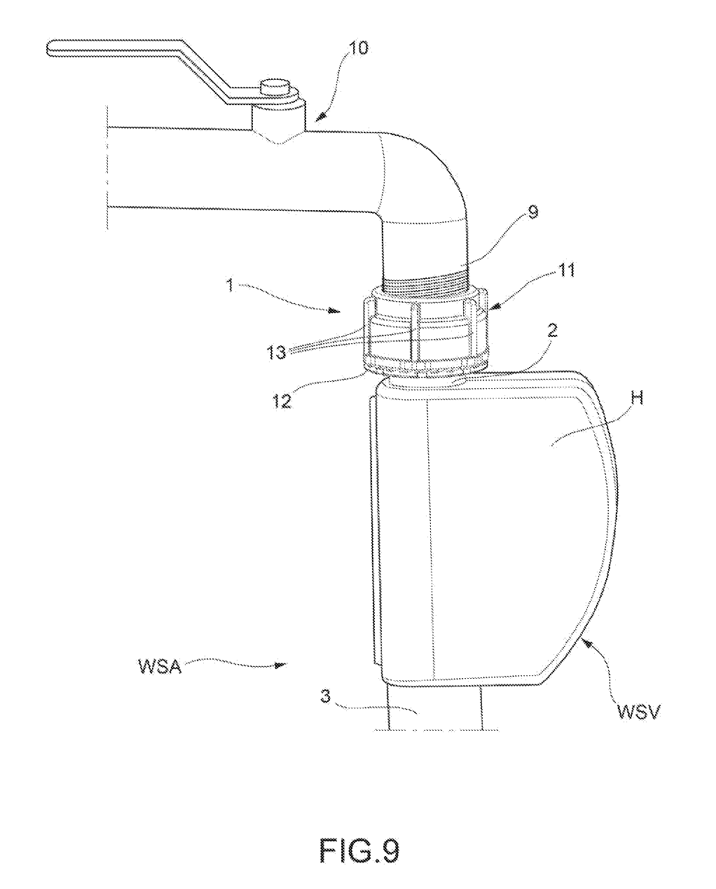

In FIG. 9 of the appended drawings, the inlet tubular member 2 of the water-stop valve WSV is coupled through a connecting device 1 according to the present invention with a threaded tubular outlet port 9 of a tap 10 controlling the supply of a flow of water from a water supply line.

FIG. 9 will be further described in the following.

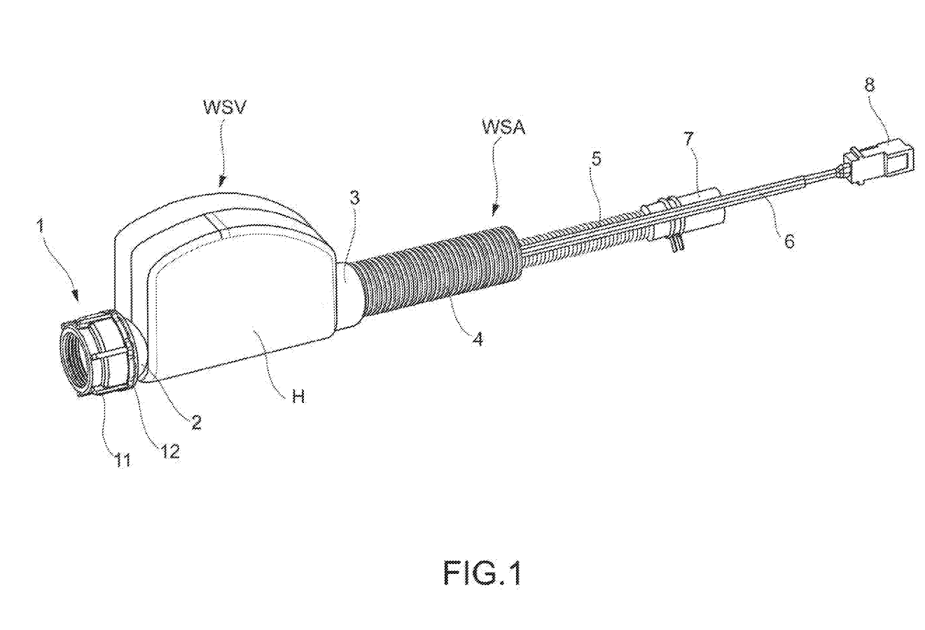

With reference in particular to FIGS. 1 to 4, a connecting device according to the present invention essentially comprises a nut 11 and a coupling ring 12, adapted to be screw-fastened to one another.

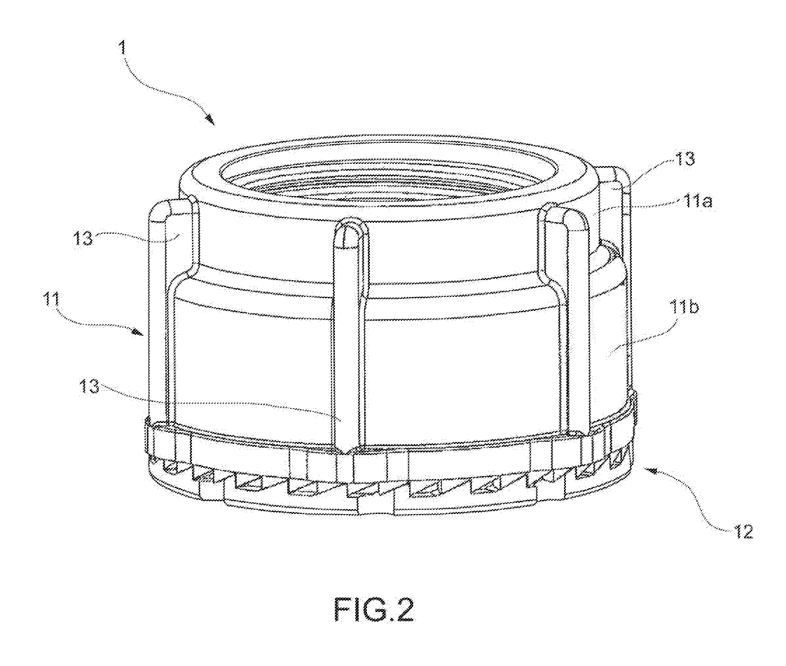

With reference in particular to FIGS. 2, 3 and 8, the nut 11 has first and second axial end portions 11a, 11b which are internally threaded and preferably have different internal diameters, the diameter of the first end portion 11a being in particular smaller than that of the second end portion 11b.

The first threaded end portion 11a of the nut 1 is adapted to be screw-coupled with the external thread of the tubular outlet port 9 of the tap 10 (FIG. 9).

The nut 11 is provided with a plurality of external longitudinal ribs 13, adapted to allow a reliable grip when said nut 11 is to be screwed.

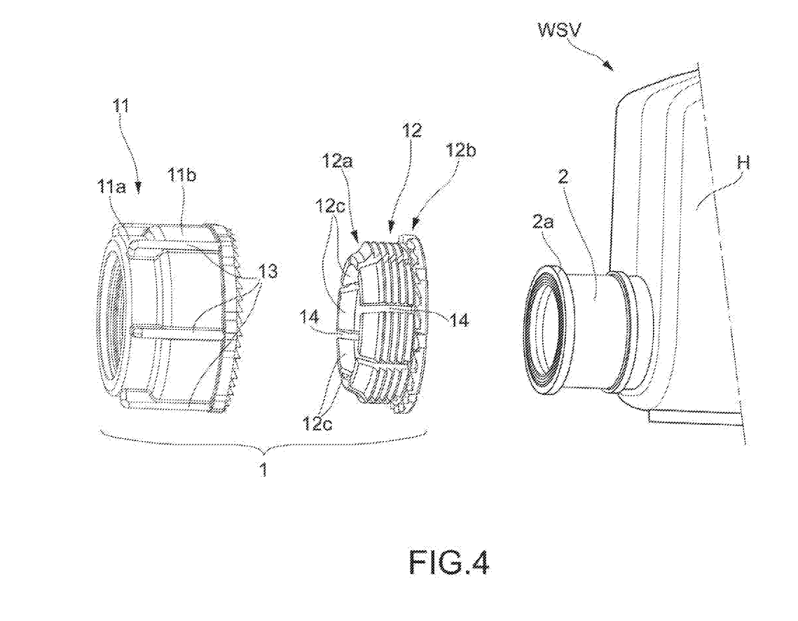

As it can be seen in FIGS. 4 to 6 and 8, the tubular inlet member 2 of the water-stop valve WSV is provided with an integral outer end shoulder or flange 2a, protruding radially towards the outside.

The coupling ring 12 is adapted to be interposed between the tubular inlet member 2 of the water-stop valve WSV and the second end portion 11b of the nut 11, for connecting them to one another, as it can be seen in particular in FIG. 8.

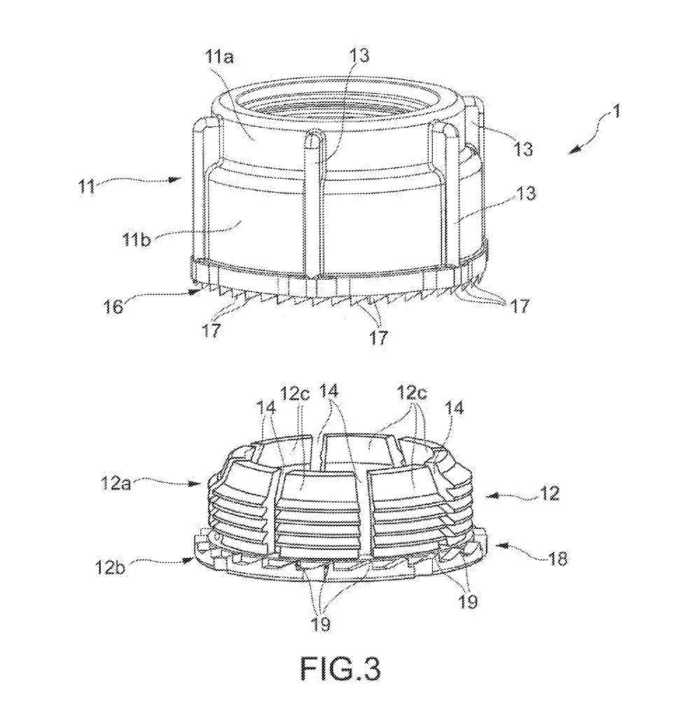

With reference to FIGS. 3 to 6, the coupling ring 12 has a first axial portion 12a forming a plurality of petal-like formations 12c, separated from one another by essentially longitudinal cut-outs 14, and extending from a second axial portion 12b of the coupling ring, which has an essentially annular configuration.

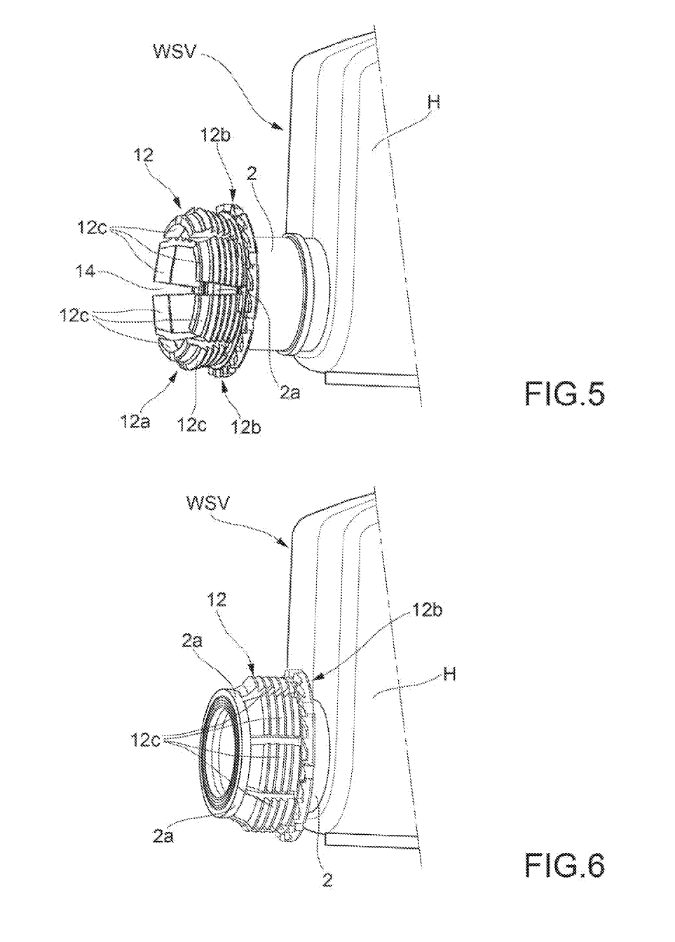

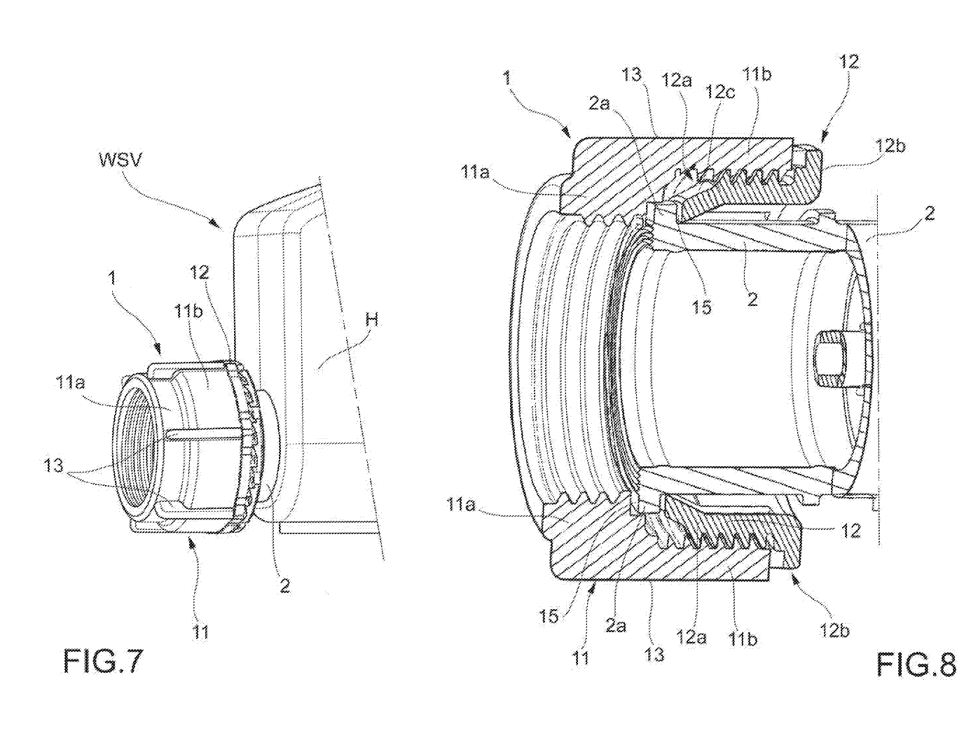

The petal-like formations 12a can be resiliently deflected in an essentially radial direction, to allow the end shoulder or flange 2a of the tubular member 2, to pass therethrough as shown by the sequence of FIGS. 5 and 6.

In the illustrated embodiment the petal-like formations 12c of the coupling ring 12 are externally provided with respective thread portions which all together form a threading adapted to engage with the internal threading of the second end portion 11b of the nut 11 (as shown in FIG. 8) when said nut 11 is screwed onto the coupling ring 12 already mounted around the tubular member 2.

As it can be seen in particular in FIG. 8 the coupling ring 12 is adapted to be mounted around the tubular member 2 in proximity of the end shoulder or flange 2a of the latter, such as to be prevented by said end shoulder or flange 2a from being taken away from the tubular member 2, but being at the same time allowed to freely rotate around the tubular member 2.

After the coupling ring 12 has been mounted around the tubular member 2, as shown by the sequence of FIGS. 5 and 6, the nut 11 can be screw-fastened onto said coupling ring, as shown in FIG. 8. In the fastened condition, a small axial gap 15 is still available between the shoulder or flange 2a and the adjacent ends of the petal-like formations 12c of the coupling ring, so that the assembly formed by the nut 11 and the coupling ring tightly screw-fastened to one another remains freely rotatable around the tubular member 2, to allow the nut 11 to be screwed onto the threaded port 9 of the tap 10, as shown in FIG. 9.

The nut 11 and the coupling ring 12 can be conveniently provided with respective first and second engagement members adapted to prevent them from being unscrewed one from the other after they have been screw-fastened to each other.

In the embodiment shown in the appended drawings (see for instance FIG. 3), the nut 11 in its second end portion 11b is provided with a circumferential crown 16 of saw-teeth 17, having a predetermined pitch, whereas the second axial portion 12b of the coupling ring 12 is provided with a crown 18 of saw-teeth 19 separated from one another, such that their pitch is twice that of the nut 11.

The arrangement is such that when the nut 11 is screwed onto the coupling ring 12, towards the end of the screwing one every two teeth 17 of the nut 11 with its slanted surface engages a corresponding slanted surface of a tooth 18 of the coupling ring 12. By prosecuting the screwing rotation of the nut 11, due to the resiliency of the materials with which the nut 11 and the coupling ring 12 are made, the teeth 17 of the nut 11 will “overcome” the “peaks” of the teeth 18 of the coupling ring 12, and this process continues until when no further screwing of the nut is possible.

The shape of the saw-teeth 17 of the nut 11 and the teeth 19 of the coupling ring 12 is such that it is thereafter impossible to unscrew the nut from the coupling ring 12: thus, they are so tightly screw-fastened to one another that they subsequently behave like a single body when the nut 11 is screwed onto the threaded port 9 of the tap 10.

The connecting device of the present invention can be easily manufactured and installed, and is extremely reliable.

Naturally the principle of the invention remaining the same, many details of constructions may be changed with respect to the embodiment described and illustrated herein, without departing from the scope of the invention as defined in the appended claims.

1. A connecting device for coupling a tubular member having on one end an outer shoulder or flange to a threaded tubular port,
the connecting device comprising:
a nut with a first threaded end portion adapted to be screw-coupled with said port and a second end portion adapted to receive said end of the tubular member, and
a coupling ring adapted to be interposed between the tubular member and said second end portion of the nut for connecting them to one another;
the coupling ring being resiliently deformable in a radial direction and being adapted to be mounted around the tubular member, in proximity of the end shoulder or flange thereof, such as to be prevented by said end shoulder or flange from being taken away from the tubular member, but to be allowed to freely rotate around said tubular member;
said second end portion of the nut and the coupling ring being threaded such as to allow the nut to be screw-fastened to the coupling ring after the latter has been mounted on the tubular member, before the nut is screw-fastened to said tubular port;
the nut and the coupling ring being provided with respective first and second engagement members adapted to prevent them from being unscrewed one from the other.

2. Connecting device according claim 1, wherein said first and second engagement members of the nut and the coupling ring comprise respective circumferential crowns of saw-teeth adapted to engage with one another in the direction of the screwing coupling of the nut with the coupling ring, and preventing their disengagement in the opposite direction.

3. Connecting device according to claim 1, wherein the coupling ring comprises:
a first axial portion forming a plurality of petal-like formations resiliently deflectable in an essentially radial direction to allow the end shoulder or flange of the tubular member to pass therethrough, and
a second axial portion which is essentially annular.

4. Connecting device according to claim 3, wherein said petal-like formations of the coupling ring are externally provided with respective threads, which as a whole form a threading adapted to engage with the threading of the second end portion of the nut when the coupling ring is mounted around said tubular member.

5. Connecting device according to claim 1, wherein the first end portion and the second end portion of the nut are both threaded, but have different internal diameters, the internal diameter of the first end portion being in particular smaller than that of the second end portion.

6. Connecting device according to claim 1, wherein the nut and the coupling ring are made of a polyamide loaded with glass-fibers.
